(19) United States
(12) Patent Application Publication
(10) Pub. No.: US 2010/0258473 A1
(43) Pub. Date: Oct. 14, 2010

(54) TORSION BIASING ASSEMBLY

(75) Inventor: Reginald Breese, Spalding Lincolnshire (GB)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: TOLY PRODUCTS (U.K.) LIMITED, KINGSTON UPON THAMES, (GB)

(21) Appl. No.: 12/738,294

(22) PCT Filed: Oct. 21, 2008
(86) PCT No.: PCT/GB2008/003562

§ 371 Date: Apr. 16, 2010

(30) Foreign Application Priority Data
Oct. 24, 2007 (GB) 0720906.7

(51) Int. Cl. A45D 40/22; B23P 11/00

(52) U.S. Cl. 206/581; 29/428

(57) ABSTRACT

Embodiments of the invention relate to a cosmetic case that comprises a lid and a base comprising a tray and a base outer shell. The lid is connected to the base by a hinge. The hinge comprises a torsion biasing assembly having relatively rotatable parts which interfit to retain a torsion element, so that relative rotation of the parts changes the strain in the torsion element. The tray is connected to the lid by the hinge and the base outer shell is fitted to the cosmetic case by being attached to the tray. The base outer shell preferably comprises a stop to prevent the lid or base from dis-engaging from the torsion biasing assembly.

### BACKGROUND OF THE INVENTION

The present invention relates to a torsion biasing assembly, more particularly to a torsion biasing assembly for a cosmetic compact. The mechanism for urging the lid of a container open, such as a cosmetic compact, by a torsion spring is well known. Most commonly a helical torsion spring is disposed at the hinge connecting the lid to the base. The helical torsion spring has two arms. One arm bears against the lid and the other arm bears against the base. By closing the lid, a pre-load is imparted to the torsion spring and a latch is used to keep the lid closed on the base. When the latch is released the pre-load imparted to the torsion spring is thereby released causing the arms bearing against the lid and the base to force the container open.

In some cases, a damping mechanism is provided to permit the lid to open slowly. For example, WO2006/011355 (M.F.V. Co, Ltd) discloses a container, typically a cosmetic case, comprising a lid and a container body connected to each other by a shaft and a shaft receiving section. During assembly, the shaft is inserted into the shaft receiving section to provide a pivotable joint about the shaft axis. A torsion spring is used as discussed above to provide the necessary urging force to open the lid. The damping mechanism is provided by a viscous gel-like material between the shaft and the shaft receiving section so as to generate sufficient drag between both moveable surfaces to cause the lid to open slowly. This increases the drag between the shaft and the shaft insertion section. To assemble the container in WO2006/011355 (M.F.V. Co, Ltd), it is necessary that the torsion spring is assembled and retained separately between the lid and body portion on the shaft prior to insertion of the shaft in the shaft receiving section. Once inserted, one arm of the torsion spring is located in a recess in the lid and the other arm located in a recess located in the container body. The requirement to separately assemble the torsion spring prior to insertion in the shaft receiving section can be cumbersome, particularly by hand, and in most cases the torsion spring has to be pre-loaded in order to locate the arms of the spring which can be difficult and time consuming. For mass production, intricate tooling would be required to assemble the container and this translates into higher costs which are disadvantageous particularly for such a disposable item.

US2005/0178695 (Techpak) overcomes these problems by providing a hinge mechanism formed by engagement of a first hinge element on a lid and a second hinge element on a cosmetic container bottom, in which the torsion biasing assembly is pre-packaged into one of the hinge elements prior to assembly of the lid to the bottom of the cosmetic case.

US2003/0173369 (Rexam) describes a cosmetic container having a cover and a base and which includes a hinge assembly incorporating a spring for pivoting the cover from a closed position to an open position relative to the base. The spring is pre-packaged in the hinge assembly prior to coupling the cover to the base by being retained within a cavity defined by a housing or cylindrical sleeve and a plug. The housing or cylindrical sleeve is rotatable relative to the plug so as to impart a strain to the spring when the lid is rotated towards the base. The hinge assembly includes a supplemental attachment or fastener in the form of a pin inserted through an aperture to secure the cover to the base.

The cosmetic container described in JP2006000515 (Nifco) comprises a lid, an inner lid and a base each having a hinge portion which inter-fit to receive a hinge shaft. The hinge shaft is pre-packaged with a biasing element so as to bias the lid in an open configuration relative to the base.

Despite steps being made to pre-package the torsion biasing element prior to assembly onto the cosmetic container, the process for assembling such cosmetic cases is still labour intensive requiring a significantly higher level of dexterity compared to a cosmetic case without a torsion biasing assembly. This leads to reduced flexibility in design and increased manufacturing costs.

As there is increased pressure to drive down the cost of what is essentially a disposable item, a cosmetic case having a torsion biasing assembly is thus required that can easily be assembled. More particularly, a cosmetic case is required that can be easily assembled without any dexterity or skill and yet have the advantages and functions of a cosmetic case incorporating a torsion biasing assembly.

### SUMMARY OF INVENTION

The present applicant has mitigated the above problem by providing a cosmetics case comprising a lid and a base, the lid being connected to the base by a hinge so as to allow rotation of the lid relative to the base along a hinge axis, the hinge comprising a torsion biasing assembly having relatively rotatable parts which interfit to retain a torsion element, so that relative rotation of the parts changes the strain in the torsion element wherein the base comprises a tray and a base outer shell, the tray is connected to the lid by the hinge and the base outer shell is fitted to the cosmetics case by being attached to the tray.

By retaining the torsion element between relatively rotatable interfitting parts, the torsion element is pre-packaged prior to assembly of the cosmetic case thereby removing the need to separately handle the torsion element during such assembly. This enables the case to be assembled easily without the need to separately handle and fit the torsion element. Preferably one of the parts is axially engageable with the torsion element on assembly. The relatively rotatable parts may therefore be interfitted at the same time as the torsion element is engaged with the one part. In combination to the pre-packaged torsion biasing assembly, the present applicant has realised that the base assembly of the cosmetic case may be completed by attaching a base outer shell to the tray by a snap on engagement, or any other suitable fixings, such as adhesive or ultrasonic welding, or even mechanical fasteners such as screws. The base outer shell can either be fitted onto the tray after the tray has been rotated to the closed position relative to the lid or when in a 180° open position or any position between the open and closed position. The ability to attach the tray to the lid prior to fitting the base outer shell provides a convenient means to attach the lid to the base assembly using the torsion biasing assembly of the present invention. This also removes the need to provide a separate hinge element on the base outer shell in order for it to be hingedly attached to the lid. Such an arrangement removes the need to separately align each of the hinge portions of the lid, tray and the base outer shell of the cosmetic case in order to receive a hinge shaft as taught in JP2006000515 (Nifco). For example, the cosmetic case can be assembled by simply sliding the base, more particularly the tray or lid into engagement with one of the rotatable parts. Preferably, the lid is connected to the base by axially engaging with the torsion biasing assembly along the hinge axis. More preferably, the tray is formed with hinge elements that engage with the torsion biasing assembly to form a pivotable hinge. The torsion biasing assembly can either be attached to the base or lid or integrally formed with the base or lid.

Preferably the base outer shell comprises a stop to prevent the lid or base from axially dis-engaging from the torsion biasing assembly. The stop is preferably integrally formed with the base outer shell and engages with one of the hinge elements to prevent axial movement of the lid or base from the torsion biasing assembly. More preferably, the base outer shell comprises a latch which cooperates with a corresponding recess on the lid to lock the lid closed on the base. Thus in use, when the latch is actuated by the user, the energy stored in the torsion element is released causing the lid to pivot open. Preferably, the base outer shell comprises a peripheral wall and the latch forms part of this wall or is disposed in a cut out in the wall. This improves the aesthetic look and feel of the cosmetic case and minimises any protruding elements attributable to the latch. More preferably, the latch is disposed in opposite walls of the base so enabling the cosmetic case to be opened by one hand.

Optionally, the torsion element is confined within the interfitting rotatable parts. Preferably the parts provide relatively movable surfaces between which a viscous damping medium is accommodated. This advantageously permits a damping mechanism to be incorporated to dampen the biasing effects of the torsion element and so allows the lid of a container to open slowly, thereby giving it a quality feel.

Optionally, the torsion element is a coiled spring and the spring has a diametrical formation engageable with a diametrical slot in one of the rotatable parts. Thus, by rotating one of the parts, the strain in the coiled spring changes and a returning torsional force is thereby generated which can be used to open the lid of a container.

In one aspect of the present invention, the rotatable parts are respectively connected to the lid and the tray of the cosmetic case. Preferably, one of the rotatable parts comprises a lug engageable within a recess in the lid or base so that rotation of the lid or base causes said part to rotate and thereby change the strain in the torsion element. Preferably the lug has a splined or knurled surface so as to non-rotatably retain the lug in the recess.

The present applicant has provided a method of manufacture of a cosmetic case as defined in any of the preceding claims, the method comprising the steps of:
a. assembling the torsion biasing assembly onto the lid;
b. assembling the tray onto the lid by axially engaging with the torsion biasing assembly along the hinge axis so that the lid forms a pivotable joint with one of the rotatable interfitting parts of the torsion biasing assembly, and
c. fitting the base outer shell to the tray.

This enables the cosmetic case to be easily assembled without the need to separately assemble the torsion element or spring. Once assembled, rotation of the lid changes the strain in the torsion element and thus a pre-load is then imparted to the torsion element. Preferably, the base comprises a tray, the tray being pivotally connected to the lid by the hinge. Connecting the tray to the lid allows the torsion element to be assembled with any selected pre-tension when the lid is closed. More preferably, the tray is pivotally connected to the lid initially in a substantially open orientation (e.g. 180° open). This enables the tray to be connected to the lid without the need to impart a pre-load to the torsion element. Rotation of the tray then imparts a pre-load to the torsion element. Thus, the cosmetic case can be manufactured easily and at little cost. To further contribute to the low cost of manufacture, the lid, the tray and base outer shell are each formed substantially as a single body, e.g. by injection moulding.

### BRIEF DESCRIPTION OF THE DRAWINGS

Further preferred features and aspects of the present invention will be apparent from the dependent claims and the following illustrative embodiment made with reference to the accompanying drawings in which:—

FIG. 1 is a schematic representation of the component parts of the torsion biasing assembly of the present invention;

FIG. 2 is a cross-sectional view of the assembled torsion biasing assembly;

FIG. 3 is an inside view of the interior of the rotatable interfitting parts showing the diametrical slot for engagement with the spring.

FIG. 4 is a perspective view of the torsion biasing assembly attached to the lid of a cosmetic case;

FIG. 5 is an expanded view of the hinge mechanism formed by the torsion biasing assembly of the present invention;

FIG. 6 is a top view of the lid hingedly connected to the tray of the base;

FIG. 7 is a bottom view of the lid hinged to the tray;

FIG. 8 is a bottom view of the closed cosmetic case before completion of the base assembly.

FIG. 9 is a perspective view of the base showing of the latch mechanism;

FIG. 10 is a perspective view of the latch.

### DESCRIPTION OF THE PREFERRED EMBODIMENT

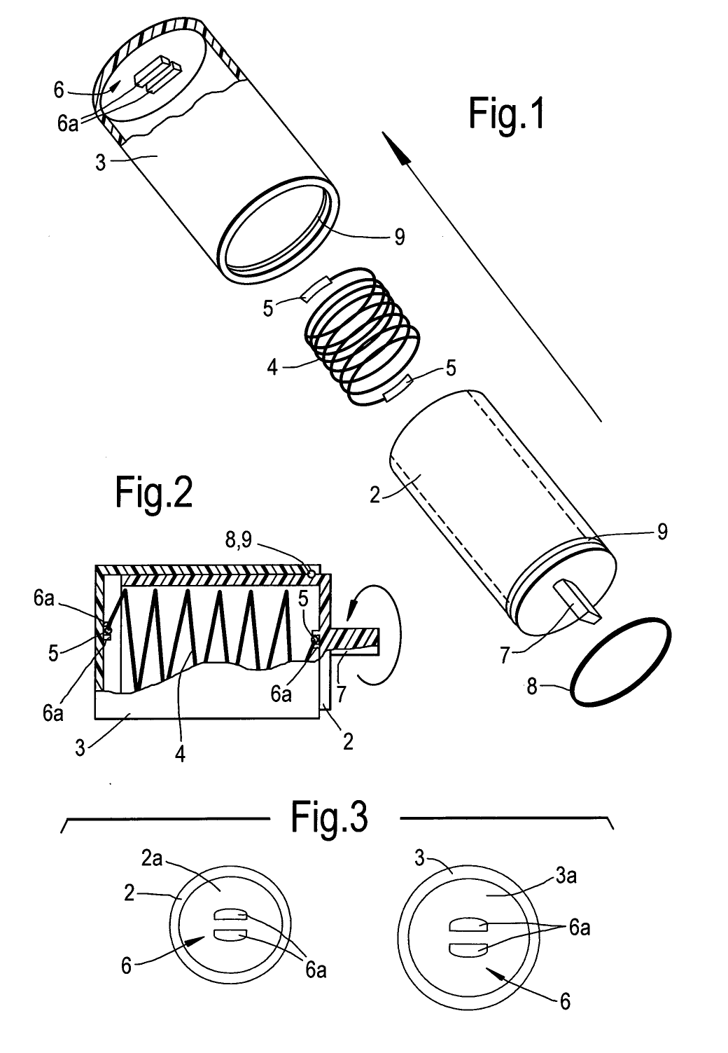

An illustrative embodiment of the torsion biasing assembly 1 used in the present invention shown in FIG. 1 comprises generally cylindrical male 2 and female 3 parts that are interfitted so that both parts can rotate with respect to each other. The female part 3 has a slightly larger bore diameter than the external diameter of the male part 2 so permitting the male part 2 to be axially receivable in the female part 3 (see arrow in FIG. 1). Both parts are hollow and configured as a tubular casing so as to accommodate and retain a torsion element 4 (see FIG. 2). When one of the parts is rotated the strain in the torsion element 4 is changed. In the particular embodiment, the torsion element 4 is in form of a helical spring and is housed or confined within the walls of the interfitted parts 2, 3 (see FIG. 2). The ends of the coiled spring have diametrical protrusions or formations 5 which engage with corresponding diametrical slots 6 formed in respective back walls 2a, 3a of the interfitting parts 2, 3 (see FIG. 3). The diametrical slots are defined between D cross-sectional upstanding pillars 6a between which the spring diametrical end portions 5 are secured. When one of the parts rotates, the corresponding end of the helical spring is constrained to rotate with the moving part whilst the other end stays fixed, so changing the torsional strain in the spring. Other means to constrain the ends of the spring within the rotatable interfitting parts so as to induce torsion to the helical spring 3 when one of them is rotated are permissible.

To assemble the torsion biasing assembly 1 to a cosmetic case, at least one of the parts 2, 3 has a protruding lug 7 having a knurled or splined surface that is receivable in a corresponding recess in a lid or base of the case so as to form a non-rotatable joint. Rotation of the lid causes one the parts to rotate relative to the other against the bias of the helical spring thereby imparting a pre-load on the spring. In the particular embodiment, the male part 2 has a protruding splined lug 7 receivable in a corresponding splined recess 7a in a base tray of the container. Further details of the assembly of the torsion biasing assembly to the cosmetics case, are discussed later.

A damping mechanism can be additionally incorporated within the torsion biasing assembly 1 by disposing grease or another suitable viscous substance such as silicone gel between the relatively rotatable surfaces of the interfitting parts 2, 3. An O-ring 8 can be optionally located in a groove 9 on the male part so as provide a seal at the mouth of the interfitting parts to prevent the grease from escaping and/or entry of contaminants and to offer a frictional surface between the movable parts. As is known in the art, a damping mechanism permits the lid of a container to open slowly and give it a quality look and feel.

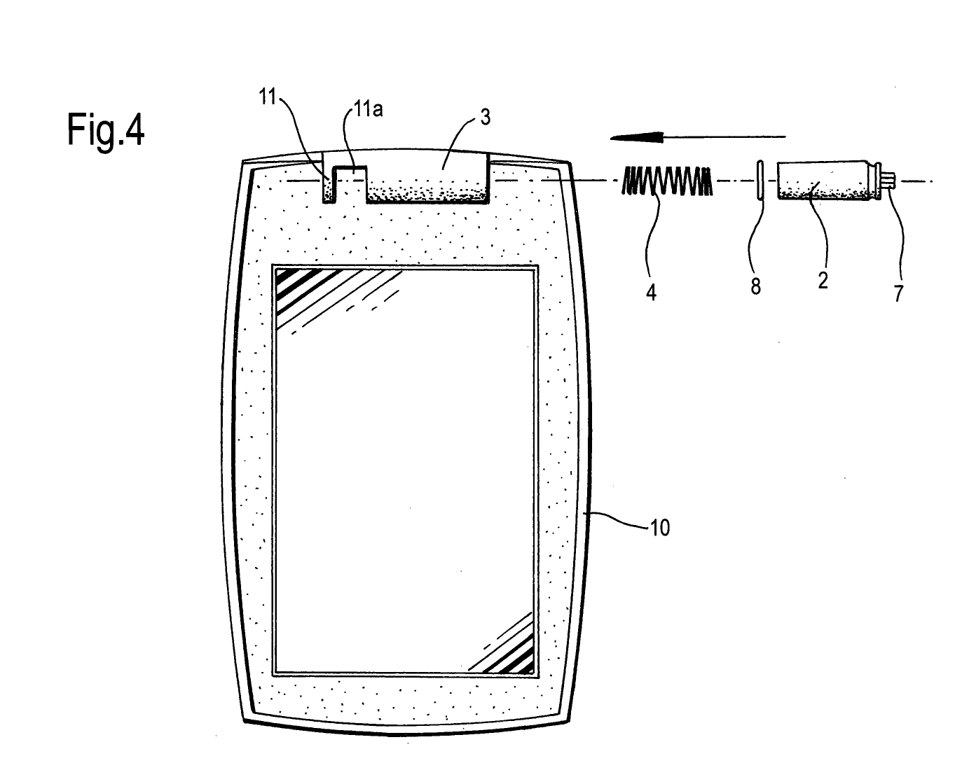

The cosmetics case incorporating the torsion biasing assembly 1 of the present invention provides the necessary urging force to automatically open the lid of the container when a latch is released. FIG. 4 shows the lid 10 of the cosmetics case whereby one of the walls of the lid 10 is formed with the torsion biasing assembly of the present invention so forming the hinge of the case. As can be seen in FIG. 4, the female part 3 is formed with the lid 10. The helical spring 4 and male part 2 are inserted in an axial direction (see arrow) into the female part 3 to retain the helical spring 4. The female part 3 can either be attached to the lid 10 or integrally formed with the lid 10 such as by injection moulding.

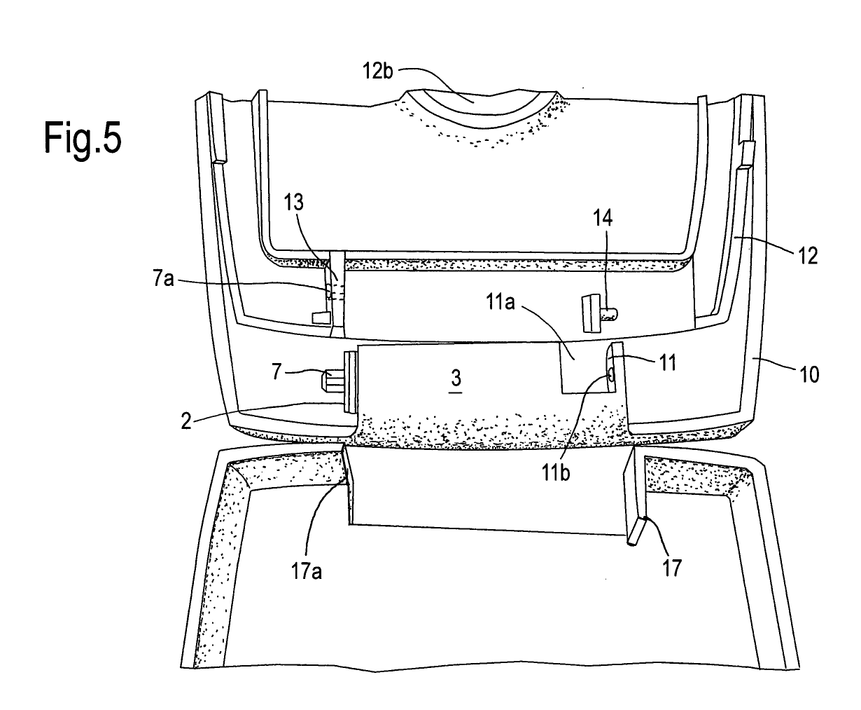

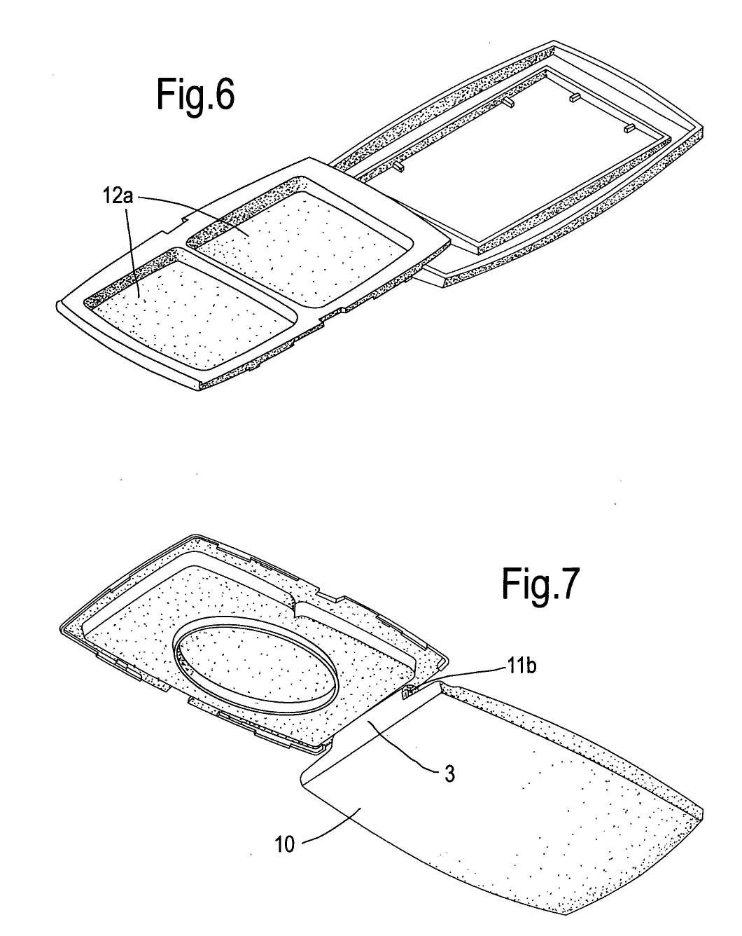

The lug 7 is formed with a knurled or splined surface that is receivable in a corresponding recess so as to form a non-rotatable joint. At the other end of the hinge is an anchor boss 11 formed with a recess 11b for receiving a corresponding lug (see FIG. 5). A gap 11a is shown between the anchor boss 11 and the female part 3 of the torsion biasing assembly to enable a corresponding lug to be easily positioned in registration with and engage into the recess of the anchor boss 11. A tray 12 forming part of the base of the cosmetic case is formed with a boss 13 with a splined recess 7a for non-rotatingly receiving the splined lug 7 of the lid 10 so that rotation of the tray 12 relative to the lid 10 causes the male part 2 of the torsion biasing assembly to rotate relative to the female part 3 and thereby change the strain of the spring (see FIG. 5). The spring is confined within the walls of the interfitting parts 2, 3. To complete the hinge, the tray 12 is also formed with a lug 14 at the other end of the hinge which is received in the recess 11b of the anchor boss 11 of the lid 10. FIG. 5 shows the component parts forming the hinge mechanism of the cosmetic case. The front face of the tray is formed with one or more depressions 12a for storing an applicator and/or cosmetic material (see FIGS. 6 and 7). The back face of the tray can be formed with an outwardly extending protrusion or ring 12b that sits against the bottom wall 18 of the base outer shell 15 (see FIG. 9) so as to support the tray 12 when fully assembled onto the cosmetic case.

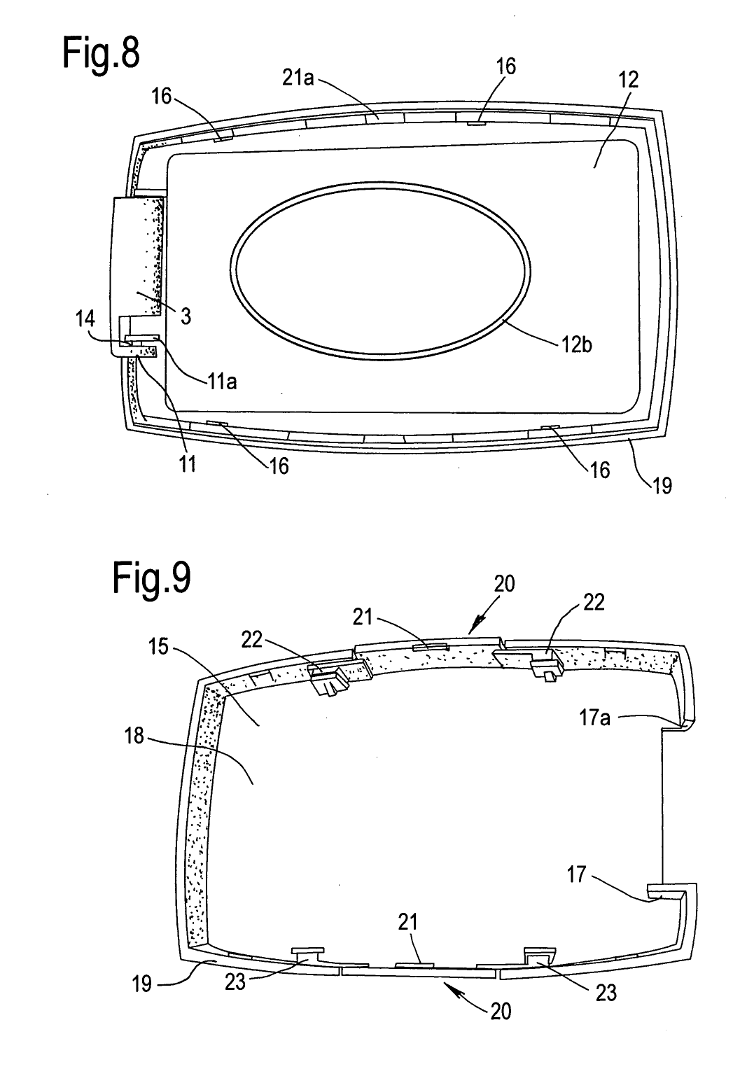

To assemble the cosmetic case, the tray 12 is first positioned around the hinge so that its lug 14 and the recess 7a of the boss 13 are respectively in axial registration with the corresponding recess 11b of the anchor boss 11 and lug 7 of the torsion biasing assembly forming part of the lid. To pivotally connect the tray 12 to the lid 10 without pre-loading the spring, the tray 12 is assembled with the lid 10 in a substantially 180° open orientation (see FIGS. 6 and 7). By sliding the tray 12 axially along the hinge line, the lugs (7, 14) and corresponding recesses 11b, 7a formed by the bosses (11, 13) then engage to form a pivotable joint (lug 14 rotating in recess 11b, and male part 2 rotating in female part 3). In this position, no pre-load is applied to the spring. A pre-load is applied to the spring when the tray 12 is rotated towards the lid 10. Once the tray is closed against the lid, (see FIG. 8), the base outer shell 15 can be attached to the back face of the tray 12 to complete the cosmetic case and prevent the tray 12 from dis-engaging from the lid 10. In the particular embodiment, the base outer shell 15 is attached to the tray by a snap-on engagement 16. The base outer shell 15 need not be attached to the tray 12 when the tray is closed against the lid. For example, the base outer shell 15 can be attached to the lid when in a 180° open position or equally any position between and including open/closed.

The base outer shell 15 additionally comprises a stop 17 which is located adjacent the hinge mechanism so that when assembled with the tray prevents the lid from sliding in an axial direction and dis-engaging the torsion biasing assembly from the tray. In the particular embodiment, the stop 17 engages with the anchor boss 11 when the base outer shell 15 is attached onto the tray 12.

The base outer shell 15 is shown with a bottom wall 18 and a peripheral wall 19 so forming a depression for accommodating the tray. In the particular embodiment shown in the drawings, the hinge mechanism is received in a cut-out in the peripheral wall 19 adjacent the hinge mechanism. In one embodiment, a portion of the peripheral wall 19 extends inwardly towards the interior of the base outer shell to form the stop 17 that engages with the anchor boss 11 as shown in FIG. 5. Alternatively, the edges of the cut-out 17a of the peripheral wall 19 adjacent the hinge mechanism butt up against the anchor boss 11 and the boss 13 to prevent lateral movement of the tray 12 and hence, base relative to the lid 10.

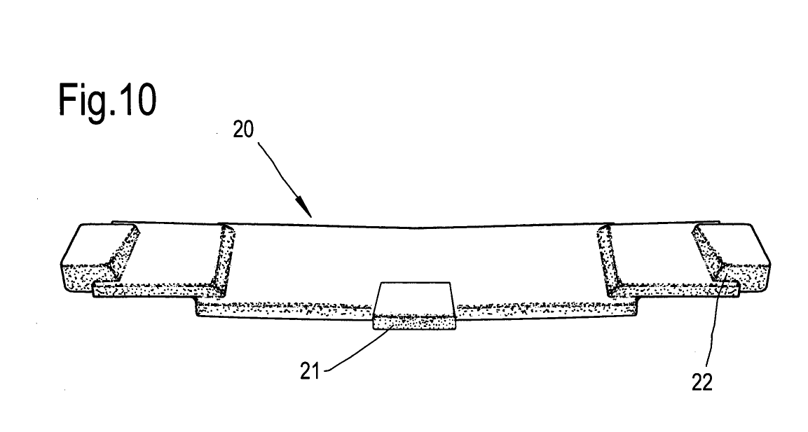

A latch 20 for holding the lid closed on the base is disposed in a further cut-out in the peripheral wall 19. As can be seen, two such latches 20 are disposed opposite one another. The latch 20 is formed as a thin strip with a hook 21 (see FIG. 10) that engages with a corresponding hole 21a (see FIG. 8) in the lid. When transverse pressure is applied to the thin strip it flexes and the hook 21 dis-engages from the hole 21a thereby permitting the lid to open. The latch 20 is secured to the base by having two wedge shaped formations 22 at either end, which are received in channels 23 (see FIG. 10) adjacent the cut-out in the peripheral wall 19 of the base outer shell 15. By having the latches 20 disposed in opposite walls, the cosmetic case can be easily be opened with one hand by simply resting the base of the cosmetic case on the palm of the user's hand and depressing the latches with a thumb and finger.

1. A cosmetics case comprising a lid and a base, the lid being connected to the base by a hinge so as to allow rotation of the lid relative to the base along a hinge axis, the hinge comprising a torsion biasing assembly having relatively rotatable parts which interfit to retain a torsion element, so that relative rotation of the parts changes the strain in the torsion element wherein the base comprises a tray and a base outer shell, the tray is connected to the lid by the hinge and the base outer shell is fitted to the cosmetics case by being attached to the tray wherein the base comprises a stop to prevent the lid from sliding and the torsion biasing assembly is thereby prevented from dis-engaging from the tray.

2. The cosmetics case of claim 1, wherein the base outer shell is attached to the tray by a snap-on engagement.

3. (canceled)

4. The cosmetics case of claim 1, wherein the base comprises a latch which cooperates with a corresponding recess in the lid to lock the lid closed on the base.

5. The cosmetics case of claim 1, wherein the base outer shell comprises a peripheral wall and the latch forms part of the peripheral wall.

6. The cosmetics case of claim 5, wherein the latch is disposed in a cut-out in the peripheral wall.

7. The cosmetics case of claim 5, wherein a pair of said latches is disposed one in each of opposite sides of the peripheral wall.

8. The cosmetics case of claim 6, wherein the latch is wedged in a channel formed adjacent to the cut-out.

9. The cosmetics case of claim 1, wherein the torsion element is confined within the interfitting rotatable parts.

10. The cosmetics case of claim 1, wherein one of the parts is axially engageable with the torsion element on assembly.

11. The cosmetics case of claim 1, wherein the parts provide relatively movable surfaces accommodating a viscous damping medium.

12. The cosmetics of claim 1, wherein the torsion element is a coiled spring.

13. The cosmetics case of claim 12, wherein the coiled spring has diametrical formation engageable with a diametrical slot in one of the parts.

14. The cosmetics case of claim 13, wherein the diametrical slot is formed by up-standing pillars.

15. The cosmetics case of claim 1, wherein the relatively rotatable parts are respectively connected to the lid and the base of the cosmetic case.

16. The cosmetics case of claim 15, wherein one of the relatively rotatable parts comprises a lug non-rotatably engageable within a recess in the lid or base so that rotation of the lid or base changes the strain in the torsion element.

17. The cosmetics case of claim 16, wherein the lug has a splined or knurled surface.

18. The cosmetics case of claim 1, wherein the lid is configured so as to connect to the tray by axially engaging with the torsion biasing assembly along the hinge axis.

19. The cosmetics case of claim 18, wherein one of the rotatable interfitting parts is non-rotatably attached to the lid such that rotation of the lid changes the strain in the torsion element.

20. The cosmetics case of claim 19, wherein one of the rotatable interfitting parts is integrally formed with the lid.

21. A method of manufacture of a cosmetic case comprising a cosmetic case of claim 1, the method comprising the steps of:
a. assembling the torsion biasing assembly onto the lid;
b. assembling the tray to the lid by axially engaging with the torsion biasing assembly along the hinge axis so that the lid forms a pivotable joint with one of the rotatable interfitting parts of the torsion biasing assembly, and
c. fitting the base outer shell to the tray.

22. A method of manufacture of a cosmetic case of claim 21 further comprising the step of pivoting the tray about the hinge in a closed direction of the cosmetic case so as to change the strain in the torsion element and thereby impart torsion to the torsion element.

23. The method of manufacture of a cosmetic case of claim 21, wherein the method further comprising the step of snap-fitting the base outer shell to the tray.

24. The method of manufacture of a cosmetic case of claim 21, wherein the lid or base are respectively formed substantially as a single body.
